(19) United States
(12) Patent Application Publication
(10) Pub. No.: US 2024/0388977 A1
(43) Pub. Date: Nov. 21, 2024

(54) SYSTEMS AND METHODS FOR OPTIMIZED NEIGHBOR RELATIONS

(71) Applicant: Verizon Patent and Licensing Inc., Basking Ridge, NJ (US)

(72) Inventors: Said HANBALY, Prosper, TX (US); Amir SAGHIR, Frisco, TX (US)

(73) Assignee: Verizon Patent and Licensing Inc., Basking Ridge, NJ (US)

(21) Appl. No.: 18/320,675

(22) Filed: May 19, 2023

(51) Int. Cl. H04W 36/00

(52) U.S. Cl. CPC H04W 36/0061; H04W 36/0058; H04W 36/00835

(57) ABSTRACT

In some implementations, a source base station may receive, from a user equipment (UE), a report indicating a physical cell identifier (PCI) of a target cell provided by a target base station. The source base station may send, to the UE, a request for a globally unique identifier of the target cell based on the PCI of the target cell being associated with a range of PCIs associated with small cell base stations. The source base station may receive, from the UE, the globally unique identifier of the target cell based on the request. The source base station may initiate, based on the PCI and the globally unique identifier of the target cell, a handover of the UE from a source cell provided by the source base station to the target cell provided by the target base station.

### BACKGROUND

Cell densification is associated with deploying additional small cells (e.g., femtocells, picocells, and/or other access points with smaller coverage areas and/or transmit power levels than a macrocell) within a cell site to enhance network coverage and capacity.

### BRIEF DESCRIPTION OF THE DRAWINGS

FIG. 1 is a diagram of an example associated with optimized neighbor relations.

FIG. 2 is a diagram of an example environment in which systems and/or methods described herein may be implemented.

FIG. 3 is a diagram of example components of a device associated with optimized neighbor relations.

FIG. 4 is a flowchart of an example process associated with optimized neighbor relations.

FIG. 5 is a flowchart of an example process associated with optimized neighbor relations.

### DETAILED DESCRIPTION OF EXAMPLE EMBODIMENTS

The following detailed description of example implementations refers to the accompanying drawings. The same reference numbers in different drawings may identify the same or similar elements.

Establishing and maintaining accurate neighbor relations between neighboring cells associated with the cell site facilitates efficient handover processes, minimizes dropped connections, and improves quality of service (QoS). To establish and maintain accurate neighbor relations, automatic neighbor relations (ANR) techniques may be used to automatically build and maintain a neighbor list, which indicates a physical cell identifier (PCI), a globally unique identifier (e.g., a New Radio (NR) cell identifier (NCI)), an Internet Protocol (IP) address, and/or other suitable information of each neighboring cell associated with the cell site. The neighbor lists may be used to expedite handover procedures associated with the cell site, such as by bypassing NCI reporting procedures performed by a user equipment (UE) associated with the cell site.

Automatic neighbor relations (ANR) techniques enable a base station to automatically build a neighbor list which includes information associated with neighboring cells (e.g., macrocells and/or small cells, among other examples) based on past successful handovers performed by UEs. The neighbor list may include information, such as a physical cell identifier (PCI), a globally unique identifier (e.g., a New Radio (NR) cell identifier (NCI)), and/or an Internet Protocol (IP) address of the neighboring cells, which can be used to expedite handover procedures. For example, when a first UE attempts a first handover from a source cell to a target cell, the first UE may report the PCI associated with the target cell to the source cell in a measurement report. The serving cell may then request that the UE provide an NCI associated with the target cell, and may update a neighbor list to include an entry with the PCI, NCI, and IP address associated with the target cell. Accordingly, when a second UE attempts a second handover to the target cell associated with the same PCI, the source cell may proceed with the handover procedure based on the neighbor list including an entry with the appropriate NCI and IP address associated with the PCI, thereby bypassing the NCI reporting procedure that was performed by the first UE.

Although the neighbor list may be used to expedite handover procedures, in some cases, the neighbor list may be associated with causing handover failures and/or inefficiencies. For example, if a large amount of small cells are deployed in a cell site, then there are large number of PCIs that must be maintained and/or updated via the neighbor list. This can lead to PCI confusion in handover procedures, because different cells may be associated with the same PCI. As a result, the UE and the base station may incorrectly identify a target cell or may be unable to distinguish different target cells during the handover process, resulting in handover failures and/or disruptions.

Furthermore, in some cases, the neighbor list (e.g., maintained by the base station) may include stale data (e.g., because the neighbor list is not properly maintained and/or updated). For example, small cell base stations such as femtocells are often portable devices that can be easily relocated, and a small cell can be assigned a different PCI-NCI pair after being power cycled (e.g., turned off and then turned back on). This can cause handover failures and/or delays in cases where the base station tries to connect the UE to an inappropriate cell based on the stale data. Additionally, in some cases, scanning a large neighbor list increases latency in performing handover procedures. As an example, when a UE needs to handover to a neighboring cell, the UE scans the neighbor list to determine the most suitable cell to connect to. If the neighbor list includes a large amount of information (e.g., a large number of neighbor cell entries), then the time required for the source cell to scan the neighbor list and determine the appropriate NCI associated with a PCI and complete the handover increases. This can lead to additional delays and/or disruptions during a time-sensitive handover procedure, which negatively impacts network performance and/or quality of service (QoS).

Some implementations described herein provide optimized neighbor relations (e.g., associated with neighboring cells of a cell site). For example, a source base station may receive, from a UE, a report indicating a PCI of a target cell provided by a target base station. In some implementations, the source base station may be a macrocell base station and the target base station may be a small cell base station. The report may include one or more measurements related to one or more signals that the UE received from the target base station.

In some implementations, the source base station may send, to the UE, a request for a globally unique identifier of the target cell, such as an NCI of the target cell, based on the PCI of the target cell being associated with a range of PCIs associated with small cell base stations (e.g., the range of PCIs may indicate PCIs of small cell base stations that are within a coverage area associated with the source cell). In some implementations, the source base station may compare a value of the PCI of the target cell to values included in the range of PCIs to determine whether the value of the PCI of the target cell is within the range of PCIs. The source base station may determine that the PCI of the target cell is associated with the range of PCIs based on determining that the value of the PCI of the target cell is within the range of PCIs. The source base station may initiate, based on the PCI, the globally unique identifier of the target cell, and/or the measurements satisfying one or more conditions, a handover of the UE from a source cell provided by the source base station to the target cell provided by the target base station. In this way, the source base station may refrain from adding the PCI-globally unique identifier pair of the target cell to a neighbor list (e.g., maintained by the source base station), which mitigates PCI confusion, avoids storing stale data, and reduces a size of the neighbor list. Alternatively, in some implementations, the source base station may add the PCI-globally unique identifier pair of the target cell to a neighbor list (e.g., maintained by the source base station).

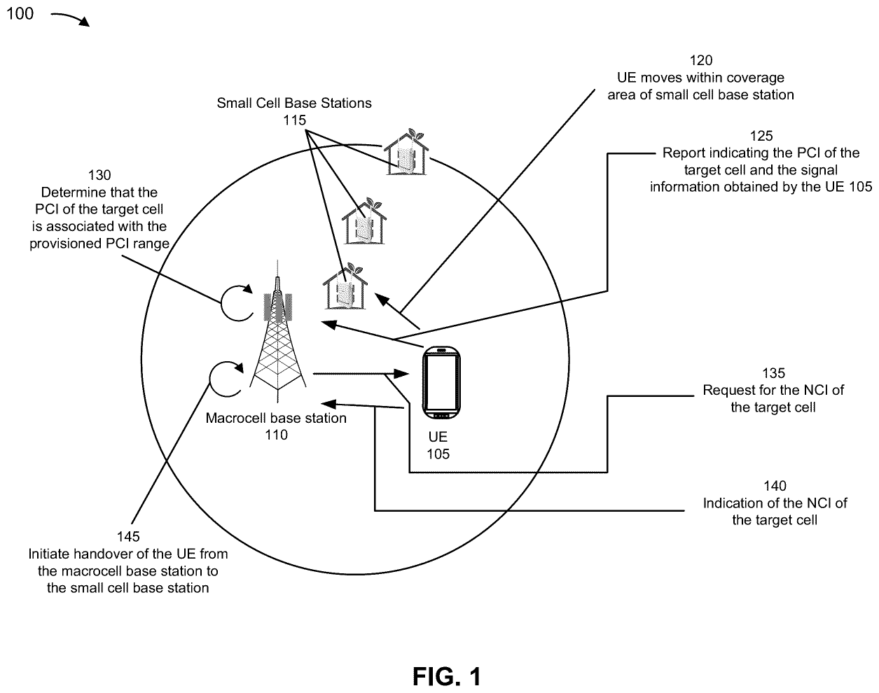

FIG. 1 is a diagram of an example 100 associated with optimized neighbor relations. As shown in FIG. 1, example 100 includes a UE 105, a macrocell base station 110, and one or more small cell base stations 115. In example 100, the macrocell base station 110 and the small cell base station(s) 115 may provide cells that cover geographic areas (e.g., the cells provided by the macrocell base station 110 and the small cell base stations 115 may be neighboring cells that cover the geographic areas, as described in more detail elsewhere herein). The small cell coverage area is smaller than the macrocell coverage area, and may be partially or entirely included in the macrocell coverage area. In some implementations, the macrocell base station 110 may be referred to as a source base station and one or more small cell base stations 115 may be referred to as a target base station. The UE 105 may have an active connection with a cell of the macrocell base station 110, which may also be referred to as a source cell of the source base station. In some implementations, the source base station may initiate a handover of the UE 105 from the source cell of the source base station 110 to a target cell of a small cell base station 115, which may be referred to as a target cell of the target base station.

In some implementations, a PCI range and a globally unique identifier (e.g., an NCI) range may be assigned to the cells that are provided by the small cell base stations 115 (e.g., that provide cells associated with coverage areas that are partially or entirely included in the coverage area of the cell provided by the macrocell base station 110 or otherwise neighbor the cell provided by the macrocell base station 110). For example, a mobile network operator (MNO) may dedicate a PCI range and a corresponding globally unique identifier range to the cells provided by the small cell base stations 115. The PCI range may be any suitable PCI range and the globally unique identifier range may be any suitable globally unique identifier range. As an example, a mobile network operator (MNO) may dedicate a PCI range (e.g., a PCI range of 957 to 1007) and a corresponding globally unique identifier range (e.g., an NCI range of F2EB80000 to F423FFFFF) to the cells provided by the small cell base stations 115. Each small cell is assigned a unique PCI, from the dedicated PCI range associated with a macrocell, via a small cell EMS when the small cell is deployed or power cycled. Each of the PCIs assigned to the cells provided by the small cell base stations 115 is within the PCI range dedicated to small cells and each of the globally unique identifiers assigned to the cells provided by the small cell base stations is within the globally unique identifier range dedicated to small cells.

In some implementations, the macrocell base station 110 may be provisioned (e.g., by the MNO) with the PCI range and the globally unique identifier range dedicated to the cells provided by the small cell base stations 115. In this way, an element management system (EMS) associated with the macrocell base station 110 and/or an EMS associated with the small cell base stations 115 do not coordinate PCI and globally unique identifier assignments, which reduces a risk of PCI and/or globally unique identifier confusion within the neighboring cells (e.g., when handover procedures are performed). For example, because the macrocell base station 110 is provisioned with the PCI range and the globally unique identifier range dedicated to the cells provided by the small cell base stations 115, the macrocell base station 110 makes handover decisions without adding the PCI-globally unique identifier pair associated with a small cell 115 to a neighbor list, such as when the UE 105 moves from a geographic area covered by a cell provided by the macrocell base station 110 to a geographic area covered by a cell provided by a small cell base station 115, as described in more detail elsewhere herein.

As shown in FIG. 1, and by reference number 120, the UE 105 moves from a first geographic area to a second geographic area. In some implementations, the UE 105 may have an active connection with a cell of the macrocell base station 110 in the first geographic area. The UE 105 may move to the second geographic area covered by a cell of a small cell base station 115 in the second geographic area. The second geographic area can wholly or partially intersect or overlap with the coverage area of the macrocell base station 110.

In some implementations, the UE 105 may detect signals and/or perform signal measurements associated with signals provided by the target base station (e.g., when the UE 105 is in the geographic area covered by the target cell). As an example, the UE 105 may detect and/or receive synchronization signals (e.g., a primary synchronization signal (PSS) and/or a secondary synchronization signal (SSS)) and/or reference signals (e.g., cell-specific reference signals (CRS) and/or channel state information-reference signals (CSI-RS)) provided by the target base station (e.g., when the UE 105 is in the geographic area covered by the target cell).

In some implementations, the UE 105 may detect a presence of the target base station and/or may identify a PCI of the target cell of the target base station based on detecting the synchronization signals. Additionally, or alternatively, the UE 105 may obtain signal information by performing signal measurements based on the synchronization and/or reference signals (e.g., which are associated with measuring a strength and/or a quality of the received reference signals). For example, the UE 105 may measure a reference signal received power (RSRP) (e.g., an average power of the received reference signals), may measure a reference signal received quality (RSRQ) (e.g., a ratio of RSRP to a total received power of the received reference signals, including interference and noise), and/or may measure a signal-to-interference-plus-noise ratio (SINR) (e.g., a ratio of the received signal power to a combined interference and noise power of the received reference signals), among other examples. The UE 105 may provide, and the macrocell base station 110 may receive, an indication of the PCI and/or the signal information, as described in more detail elsewhere herein.

As further shown by FIG. 1, and by reference number 125, the UE 105 may provide, and the macrocell 110 may receive, a report indicating the PCI of the target cell (e.g., provided by the target base station) and/or the signal information obtained by the UE 105. For example, the UE 105 may provide, and the macrocell 110 may receive, a report indicating the PCI of the target cell, the RSRP measured by the UE 105, the RSRQ measured by the UE 105, and/or the SINR measured by the UE 105, among other examples.

As further shown by FIG. 1, and by reference number 130, the macrocell base station 110 may determine that the PCI of the target cell is associated with the provisioned PCI range associated with small cells. For example, the macrocell base station 110 may compare a value of the PCI of the target cell (e.g., indicated by the report) and values indicated by the provisioned PCI range to determine whether the value of the PCI of the target cell is within the values indicated by the provisioned PCI range associated with small cells. The macrocell base station 110 may determine that the target cell is associated with the provisioned PCI range based on determining that the value of the PCI of the target cell (e.g., indicated by the report) is within the values indicated by the provisioned PCI range.

As further shown by FIG. 1, and by reference number 135, the macrocell base station 110 may provide, and the UE 105 may receive, a request for the globally unique identifier of the target cell. For example, the macrocell base station 110 may provide, and the UE 105 may receive, the request for the globally unique identifier of the target cell based on the signal measurements satisfying one or more handover conditions and based on determining that the PCI of the target cell is associated with the provisioned PCI range. In some implementations, the UE 105 may obtain the globally unique identifier of the target cell from one or more system information block (SIB) messages (e.g., broadcasted by the small cell base station 115 that provides the target cell). As an example, SIB messages may be periodically broadcasted by the macrocell base station 110 and the small cell base stations 115 to provide the UE 105 with information associated with the network, cells, and/or neighboring cells, including the globally unique identifiers of the macrocell base station 110 and/or the small cell base stations 115. Additionally, or alternatively, the UE 105 may forward, and the target base station may receive, the request for the globally unique identifier of the target cell. The target base station may provide, and the UE 105 may receive an indication of the globally unique identifier of the target cell (e.g., based on the request to provide the globally unique identifier of the target cell).

As further shown by FIG. 1, and by reference number 140, the UE 105 may provide, and the macrocell base station 110 may receive, the indication of the globally unique identifier of the target cell. In some implementations, the UE 105 may forward, and the macrocell base station 110 may receive, the indication of the globally unique identifier of the target cell.

As further shown by FIG. 1, and by reference number 145, the macrocell base station 110 may initiate handover of the UE 105 from the macrocell base station 110 to the small cell base station 115. In some implementations, the macrocell base station 110 may initiate the handover of the UE 105 to the small cell base station 115 based on the PCI and the corresponding globally unique identifier of the target cell. Furthermore, the source base station may refrain from adding the PCI-globally unique identifier pair of the target cell to a neighbor list (e.g., maintained by the source base station), which mitigates PCI confusion, avoids storing stale data, and reduces a size of neighbor list. Alternatively, in some implementations, the source base station may add the PCI-globally unique identifier pair of the target cell to a neighbor list (e.g., maintained by the source base station).

As indicated above, FIG. 1 is provided as an example. Other examples may differ from what is described with regard to FIG. 1. The number and arrangement of devices shown in FIG. 1 are provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

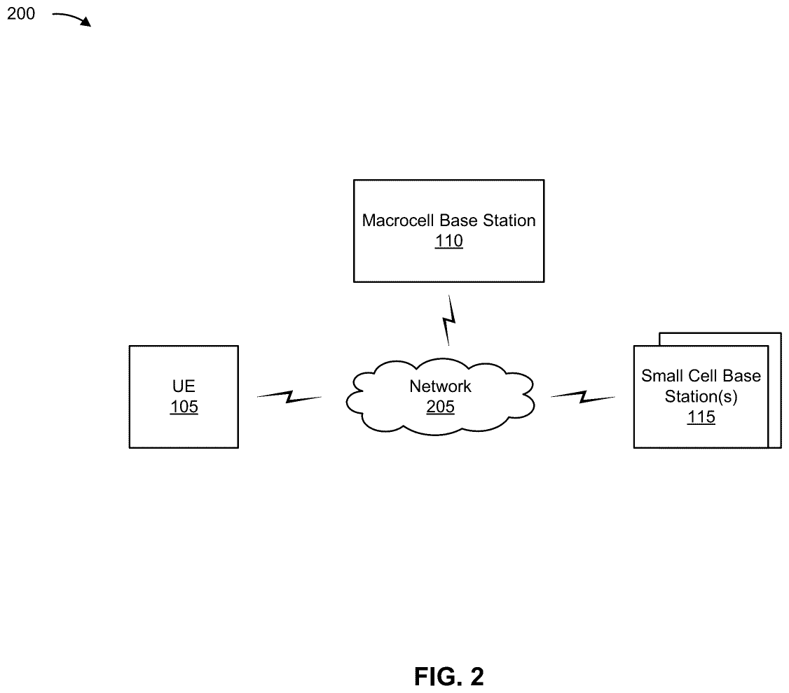

FIG. 2 is a diagram of an example environment 200 in which systems and/or methods described herein may be implemented. As shown in FIG. 2, environment 200 may include the UE 105, a macrocell base station 110, one or more small cell base stations 115, and a network 205. Devices of environment 200 may interconnect via wired connections, wireless connections, or a combination of wired and wireless connections.

UE 105 includes one or more devices capable of receiving, generating, storing, processing, and/or providing information, such as information described herein. For example, UE 105 can include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

Macrocell base station 110 may be one or more base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, or similar types of devices and other network entities that can support wireless communication for UE 105. Macrocell base stations 110 may transfer traffic between UE 105 (e.g., using a cellular radio access technology (RAT)), one or more base stations (e.g., using a wireless interface or a backhaul interface, such as a wired backhaul interface), and/or a core network. Macrocell base station 110 may provide one or more cells that cover geographic areas.

In some implementations, macrocell base station 110 may perform scheduling and/or resource management for UE 105 covered by macrocell base station 110 (e.g., UE 105 covered by a cell provided by macrocell base station 110. In some implementations, macrocell base station 110 may be controlled or coordinated by a network controller, which may perform load balancing, network-level configuration, and/or other operations. The network controller may communicate with macrocell base station 110 via a wireless or wireline backhaul. In some implementations, macrocell base station 110 may include a network controller, a self-organizing network (SON) module or component, or a similar module or component. In other words, macrocell base station 110 may perform network control, scheduling, and/or network management functions (e.g., for uplink, downlink, and/or sidelink communications of UE 105 covered by macrocell base station 110).

Small cell base station(s) 115 may be one or more microcell base stations, femtocell base stations, picocell base stations, or similar types of devices that can support wireless communication for UE 105. Small cell base station(s) 115 may transfer traffic between UE 105 (e.g., using a cellular RAT), one or more base stations (e.g., using a wireless interface or a backhaul interface, such as a wired backhaul interface), and/or a core network. Small cell base station(s) 115 may provide one or more cells that cover geographic areas.

In some implementations, small cell base station(s) 115 may perform scheduling and/or resource management for UE 105 covered by small cell base station(s) 115 (e.g., UE 105 covered by a cell provided by small cell base station(s) 115. In some implementations, small cell base station(s) 115 may be controlled or coordinated by a network controller, which may perform load balancing, network-level configuration, and/or other operations. The network controller may communicate with small cell base station(s) 115 via a wireless or wireline backhaul. In some implementations, small cell base station(s) 115 may include a network controller, a SON module or component, or a similar module or component. In other words, small cell base station(s) 115 may perform network control, scheduling, and/or network management functions (e.g., for uplink, downlink, and/or sidelink communications of UE 105 covered by small cell base station(s) 115).

The network 205 includes one or more wired and/or wireless data networks. For example, the network 205 may include an IP Multimedia Subsystem (IMS), a public land mobile network (PLMN), a local area network (LAN), a wide area network (WAN), a metropolitan area network (MAN), a private network such as a corporate intranet, an ad hoc network, the Internet, a fiber optic-based network, a cloud computing network, a third party services network, an operator services network, and/or a combination of these or other types of networks. The network 205 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

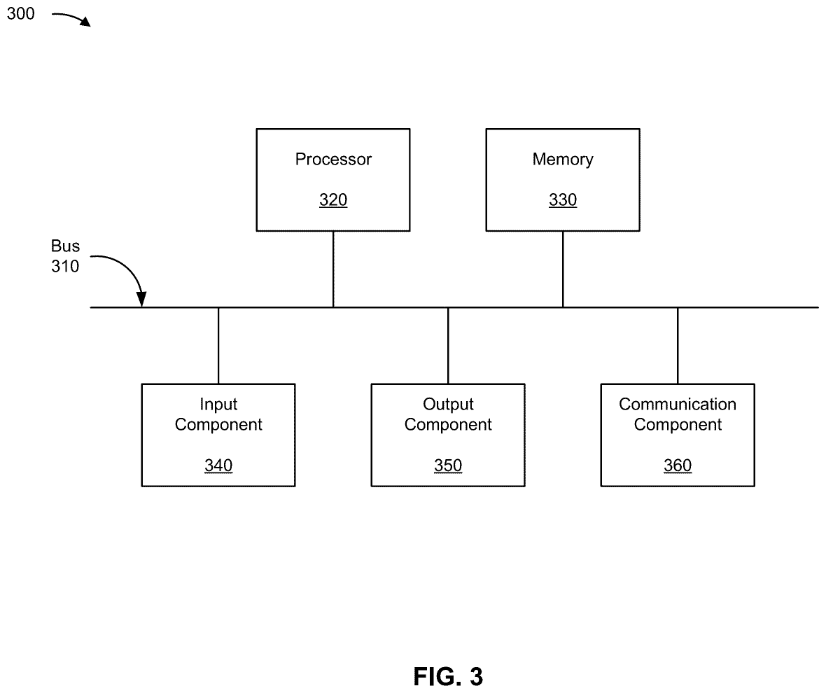

FIG. 3 is a diagram of example components of a device 300 associated with optimized neighbor relations. The device 300 may correspond to the UE 105, the macrocell base station 110, and/or the small cell base station(s) 115. In some implementations, the UE 105, the macrocell base station 110, and/or the small cell base station(s) 115 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

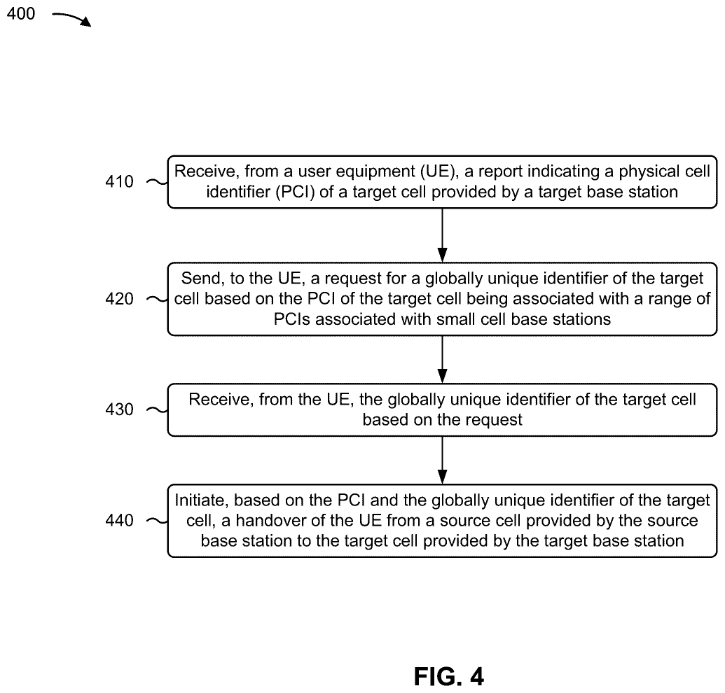

FIG. 4 is a flowchart of an example process 400 associated with optimized neighbor relations. In some implementations, one or more process blocks of FIG. 4 may be performed by a source base station (e.g., the macrocell base station 110). In some implementations, one or more process blocks of FIG. 4 may be performed by another device or a group of devices separate from or including the source base station, such as a UE (e.g., the UE 105) and/or one or more small cell base station(s) (e.g., the one or more small cell base stations 115). Additionally, or alternatively, one or more process blocks of FIG. 4 may be performed by one or more components of device 300, such as processor 320, memory 330, input component 340, output component 350, and/or communication component 360.

As shown in FIG. 4, process 400 may include receiving, from a UE, a report indicating a PCI of a target cell provided by a target base station (block 410). For example, the source base station may receive, from a UE, a report indicating a PCI of a target cell provided by a target base station, as described above. For example, the source base station may be a macrocell base station and/or the target base station may be a small cell base station. The report may include one or more measurements related to one or more signals that the UE received from the target base station.

As further shown in FIG. 4, process 400 may include sending, to the UE, a request for a globally unique identifier of the target cell based on the PCI of the target cell being associated with a range of PCIs associated with small cell base stations (block 420). For example, the source base station may send, to the UE, a request for a globally unique identifier of the target cell based on the PCI of the target cell being associated with a range of PCIs associated with small cell base stations (e.g., the range of PCIs may indicate PCIs of small cell base stations that are within a coverage area associated with the source cell), as described above. In some implementations, process 400 includes comparing a value of the PCI of the target cell to values included in the range of PCIs to determine whether the value of the PCI of the target cell is within the range of PCIs, and determining that the PCI of the target cell is associated with the range of PCIs based on determining that the value of the PCI of the target cell is within the range of PCIs.

As further shown in FIG. 4, process 400 may include receiving, from the UE, the globally unique identifier of the target cell based on the request (block 430). For example, the source base station may receive, from the UE, the globally unique identifier of the target cell based on the request, as described above.

As further shown in FIG. 4, process 400 may include initiating, based on the PCI and the globally unique identifier of the target cell, a handover of the UE from a source cell provided by the source base station to the target cell provided by the target base station (block 440). For example, the source base station may initiate, based on the PCI and the globally unique identifier of the target cell, a handover of the UE from a source cell provided by the source base station to the target cell provided by the target base station, as described above.

In some implementations, process 400 includes receiving information provisioning the source base station with the range of PCIs. The range of PCIs may be associated with a corresponding range of globally unique identifiers. In some implementations, process 400 includes maintaining a neighbor list that excludes any neighbor cells associated with the range of PCIs.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

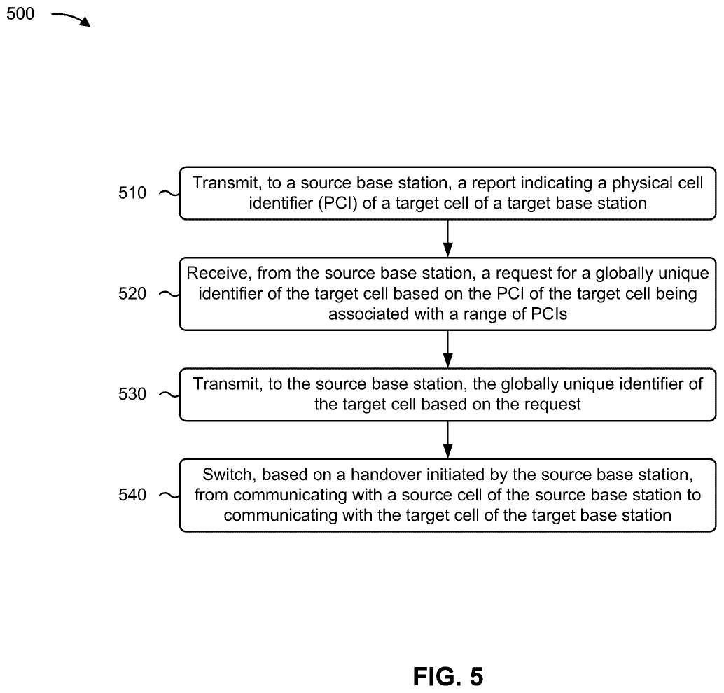

FIG. 5 is a flowchart of an example process 500 associated with optimized neighbor relations. In some implementations, one or more process blocks of FIG. 5 may be performed by a UE (e.g., the UE 105). In some implementations, one or more process blocks of FIG. 5 may be performed by another device or a group of devices separate from or including the UE, such as a source base station (e.g., the macrocell base station 110) and/or one or more small cell base stations (e.g., the one or more small cell base stations 115). Additionally, or alternatively, one or more process blocks of FIG. 5 may be performed by one or more components of device 300, such as processor 320, memory 330, input component 340, output component 350, and/or communication component 360. In some implementations, the source base station may be a macrocell base station and/or the target base station may be a small cell base station.

As shown in FIG. 5, process 500 may include transmitting, to a source base station, a report indicating a PCI of a target cell of a target base station (block 510). For example, the UE may transmit, to a source base station, a report indicating a PCI of a target cell of a target base station (e.g., based on the UE receiving one or more signals from the target cell that satisfy one or more conditions), as described above. In some implementations, the report includes one or more measurements related to one or more signals that the UE received from the target base station.

As further shown in FIG. 5, process 500 may include receiving, from the source base station, a request for a globally unique identifier of the target cell based on the PCI of the target cell being associated with a range of PCIs (block 520). For example, the UE may receive, from the source base station, a request for a globally unique identifier of the target cell based on the PCI of the target cell being associated with a range of PCI (e.g., the range of PCIs may indicate PCIs of small cell base stations that are within a coverage area associated with the source cell), as described above. In some implementations, the range of PCIs is associated with a corresponding range of globally unique identifiers.

As further shown in FIG. 5, process 500 may include transmitting, to the source base station, the globally unique identifier of the target cell based on the request (block 530). For example, the UE may transmit, to the source base station, the globally unique identifier of the target cell based on the request, as described above.

As further shown in FIG. 5, process 500 may include switching, based on a handover initiated by the source base station, from communicating with a source cell of the source base station to communicating with the target cell of the target base station (block 540). For example, the UE may switch, based on a handover initiated by the source base station, from communicating with a source cell of the source base station to communicating with the target cell of the target base station, as described above.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a source base station and from a user equipment (UE), a report indicating a physical cell identifier (PCI) of a target cell provided by a target base station;
sending, by the source base station and to the UE, a request for a globally unique identifier of the target cell based on the PCI of the target cell being associated with a range of PCIs associated with small cell base stations;
receiving, by the source base station and from the UE, the globally unique identifier of the target cell based on the request; and
initiating, by the source base station and based on the PCI and the globally unique identifier of the target cell, a handover of the UE from a source cell provided by the source base station to the target cell provided by the target base station.

2. The method of claim 1, wherein the source base station is a macrocell base station, and
wherein the target base station is a small cell base station.

3. The method of claim 1, wherein the range of PCIs indicate PCIs of small cell base stations that are within a coverage area associated with the source cell.

4. The method of claim 1, further comprising:
comparing a value of the PCI of the target cell to values included in the range of PCIs to determine whether the value of the PCI of the target cell is within the range of PCIs; and
determining that the PCI of the target cell is associated with the range of PCIs based on determining that the value of the PCI of the target cell is within the range of PCIs.

5. The method of claim 1, further comprising:
receiving information provisioning the source base station with the range of PCIs.

6. The method of claim 1, wherein the range of PCIs is associated with a corresponding range of globally unique identifiers.

7. The method of claim 1, further comprising:
maintaining a neighbor list that excludes any neighbor cells associated with the range of PCIs.

8. The method of claim 1, wherein the report includes one or more measurements related to one or more signals that the UE received from the target base station.

9. A user equipment (UE), comprising:
one or more processors configured to:
transmit, to a source base station, a report indicating a physical cell identifier (PCI) of a target cell of a target base station;
receive, from the source base station, a request for a globally unique identifier of the target cell based on the PCI of the target cell being associated with a range of PCIs;
transmit, to the source base station, the globally unique identifier of the target cell based on the request; and
switch, based on a handover initiated by the source base station, from communicating with a source cell of the source base station to communicating with the target cell of the target base station.

10. The UE of claim 9, wherein the source base station is a macrocell base station, and
wherein the target base station is a small cell base station.

11. The UE of claim 9, wherein the range of PCIs indicate PCIs of small cell base stations that are within a coverage area associated with the source cell.

12. The UE of claim 9, wherein the one or more processors are configured to transmit the report indicating the PCI of the target cell of the target base station based on the UE receiving one or more signals from the target cell that satisfy one or more conditions.

13. The UE of claim 9, wherein the range of PCIs is associated with a corresponding range of globally unique identifiers.

14. The UE of claim 9, wherein the report includes one or more measurements related to one or more signals that the UE received from the target base station.

15. A non-transitory computer-readable medium storing a set of instructions, the set of instructions comprising:
one or more instructions that, when executed by one or more processors of a source base station, cause the source base station to:
receive, from a user equipment (UE), a report indicating a physical cell identifier (PCI) of a target cell provided by a target base station;
send, to the UE, a request for a globally unique identifier of the target cell based on the PCI of the target cell being associated with a range of PCIs associated with small cell base stations;
receive, from the UE, the globally unique identifier of the target cell based on the request; and
initiate, by the source base station and based on the PCI and the globally unique identifier of the target cell, a handover of the UE from a source cell provided by the source base station to the target cell provided by the target base station.

16. The non-transitory computer-readable medium of claim 15, wherein the source base station is a macrocell base station, and
wherein the target base station is a small cell base station.

17. The non-transitory computer-readable medium of claim 15, wherein the range of PCIs indicate PCIs of small cell base stations that are within a coverage area associated with the source cell.

18. The non-transitory computer-readable medium of claim 15, wherein the one or more instructions that, when executed by the one or more processors, further cause the source base station to:
compare a value of the PCI of the target cell to values included in the range of PCIs to determine whether the value of the PCI of the target cell is within the range of PCIs; and
determine that the PCI of the target cell is associated with the range of PCIs based on determining that the value of the PCI of the target cell is within the range of PCIs.

19. The non-transitory computer-readable medium of claim 15, wherein the one or more instructions that, when executed by the one or more processors, further cause the source base station to:
receive information provisioning the source base station with the range of PCIs.

20. The non-transitory computer-readable medium of claim 15, wherein the range of PCIs is associated with a corresponding range of globally identifiers.
